(19) United States
(12) Patent Application Publication
(10) Pub. No.: US 2025/0173238 A1
(43) Pub. Date: May 29, 2025

(54) SYSTEM AND METHOD FOR DYNAMIC MONITORING

(71) Applicant: SAMSUNG ELECTRONICS CO., LTD., Suwon-si (KR)

(72) Inventors: Ho Sung Baek, Suwon-si (KR); Min Kyo Jung, Suwon-si (KR); Deuk Young Sunwoo, Suwon-si (KR)

(21) Appl. No.: 18/942,176

(22) Filed: Nov. 8, 2024

(30) Foreign Application Priority Data
Nov. 28, 2023 (KR) 10-2023-0167705

(51) Int. Cl. G06F 11/34; G06F 11/30

(52) U.S. Cl. CPC G06F 11/3442; G06F 11/301

(57) ABSTRACT

A system and method for dynamic monitoring on monitoring target resource such as computing devices are disclosed. The dynamic monitoring system comprises a memory loading dynamic monitoring program, processors executing the dynamic monitoring program and a network interface receiving metric data from a monitoring target resource. The dynamic monitoring program includes instructions for obtaining first and second representative values and first and second standard deviations of the metric data measured at first and second pluralities of measurement times, respectively, an instruction for increasing or decreasing a feedback for the monitoring target resource, using at least one of a first comparison result between the first representative value and the second representative value, and a second comparison result between the first standard deviation and the second standard deviation and an instruction for adjusting a monitoring level for the monitoring target resource based on the feedback.

### CROSS-REFERENCE TO RELATED APPLICATION

This application claims priority from Korean Patent Application No. 10-2023-0167705 filed on Nov. 28, 2023, in the Korean Intellectual Property Office and all the benefits accruing therefrom under 35 U.S.C. 119, the contents of which are herein incorporated by reference in their entirety.

### BACKGROUND

Various techniques for cyclic operational state monitoring on a monitoring target resource, such as computing devices, exist. The monitoring target resource may be a compute instance provisioned through a cloud service, or the like. That is, a system that provides the operational state monitoring technique may allow collection and analysis on one or more metrics representing the operational state of the virtual machines, and automated execution of follow-up measures according to the analysis results, by performing cyclic monitoring on one or more virtual machines provisioned through a cloud service.

### SUMMARY

Generally, operational state monitoring techniques for target resources can be inefficient in terms of management and resource efficiency, e.g., when a monitoring interval is fixed regardless of the operational state of the monitoring target resource. This inefficiency will increase as the size of monitoring target resources increases.

To avoid such inefficiencies, the present disclosure provides a dynamic monitoring method in which a monitoring policy is automatically adjusted, and a computing system for performing the method.

Another aspect of the present disclosure provides a method for performing monitoring according to a data optimized to an operational state of a monitoring target resource and a computing system for performing the method. The method for performing monitoring can also depend on an amount of change in the operational state of the monitoring target resource, a change rate, or the like, and a computing system for performing the method.

Still another aspect of the present disclosure provides a method for automatically adjusting a monitoring interval using metric data measured for a monitoring target resource, and a computing system for performing the method.

In a general aspect, a dynamic monitoring system comprises: a memory which loads dynamic monitoring program, one or more processors which execute the dynamic monitoring program and a network interface which receives metric data from a monitoring target resource. The dynamic monitoring program may include an instruction for obtaining a first representative value and a first standard deviation of the metric data measured at a first plurality of measurement times belonging to a first time window, an instruction for obtaining a second representative value and a second standard deviation of the metric data measured at a second plurality of measurement times belonging to a second time window subsequent to the first time window, an instruction for increasing or decreasing a feedback for the monitoring target resource, using at least one of a first comparison result between the first representative value and the second representative value, and a second comparison result between the first standard deviation and the second standard deviation and an instruction for adjusting a monitoring level for the monitoring target resource based on the feedback.

In another general aspect, a dynamic monitoring method comprises: receiving metric data from a monitoring target resource, obtaining a first representative value and a first standard deviation of the metric data measured at a first plurality of measurement times belonging to a first time window, obtaining a second representative value and a second standard deviation of the metric data measured at a second plurality of measurement times belonging to a second time window subsequent to the first time window, increasing or decreasing a feedback for the monitoring target resource, using at least one of a first comparison result between the first representative value and the second representative value, and a second comparison result between the first standard deviation and the second standard deviation and adjusting a monitoring level for the monitoring target resource based on the feedback.

### BRIEF DESCRIPTION OF THE DRAWINGS

FIG. 1 is a configuration diagram of an example of a computing system.

FIG. 2 is a configuration diagram of an example of a computing system.

FIG. 3 is a configuration diagram of an example of a computing system.

FIG. 4 is a configuration diagram of an example of a dynamic monitoring system.

FIG. 5 is a flowchart of an example of a dynamic monitoring method.

FIG. 6 is a detailed flowchart for an analysis operation on metric data in the dynamic monitoring method described with reference to FIG. 5.

FIGS. 7 and 8 are diagrams for determination of a length of a current time window based on a length of a previous time window.

FIG. 9 is a detailed flowchart for a monitoring level determination operation in the dynamic monitoring method described with reference to FIG. 5.

FIG. 10 is a diagram for an example of dynamic monitoring on the monitoring target resources.

FIG. 11 is a diagram of an example of a hardware configuration of a computing system.

### DETAILED DESCRIPTION

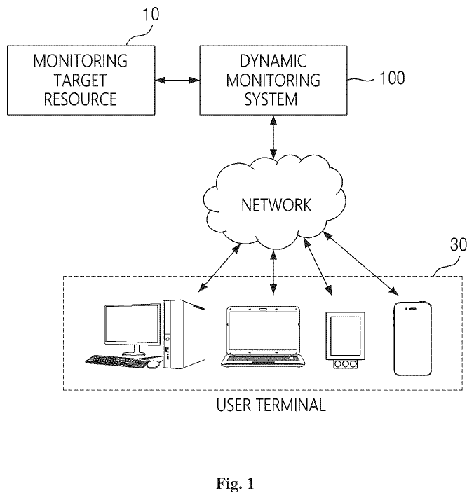

Hereinafter, an example of a configuration and operation of a computing system that supports dynamic monitoring will be described with reference to FIGS. 1 to 3.

As shown in FIG. 1, the computing system includes a monitoring target resource 10 and a dynamic monitoring system 100. The computing system may further include user terminals 30 that may be connected to the dynamic monitoring system 100 through a network. The dynamic monitoring system 100 may transmit data on a management screen (not shown) to the user terminal 30. Further, the user terminal 30 may display the management screen and transmit setting data, which is input from the user through the management screen, to the dynamic monitoring system 100. The aforementioned setting data will be described later.

The dynamic monitoring system 100 may be made up of one or more computing devices. For example, the dynamic monitoring system 100 may be made up of one or more cloud compute instances. That is, the dynamic monitoring system 100 may be made up of compute instances of at least some of one or more virtual machines and one or more containers.

Furthermore, the dynamic monitoring system 100 may be configured to include both physical servers, and the cloud compute instances. For example, when semiconductor design-related data is processed with high security requirements, a module that analyzes or at least temporarily stores the data is implemented on the on-premises physical server located on an internal network blocked by firewalls blocked from an Internet, and other modules may be configured using the cloud compute instance.

The dynamic monitoring system 100 may cyclically monitor the monitoring target resource 10. In some implementations, the dynamic monitoring system 100 may monitor the monitoring target resource 10 in a non-cyclical manner.

The dynamic monitoring system 100 may continuously and automatically adjust the monitoring level when monitoring the monitoring target resource 10 in a cyclical or non-cyclical manner. To automatically adjust the monitoring level, the dynamic monitoring system 100 may analyze metric data collected from the monitoring target resource, and adjust the monitoring level, using the analysis results. In some implementations, the monitoring level may be assigned to each monitoring target resource 10.

The metric data may include measurement data of a plurality of different metrics. The metric may be understood as a measurement target that indicates the operational state of the monitoring target resource. The metric may include, for example, a CPU usage, a memory usage, a storage I/O traffic, a network transceiver traffic, number of processes, and the like.

In analyzing the metric data, the dynamic monitoring system 100 may sense recent changes in an operational state of the monitoring target resource, by performing calculations that compare the analysis results of metric data of the first time window with the metric data of the second time window.

The second time window may be a time point subsequent to the first time window. Each of the first time window and the second time window may be made up a plurality of measurement times. The number of measurement times of the first time window and the number of measurement times of the second time window may be equal to each other.

In some implementations, the second time window may be configured to include the latest measurement time and one or more measurement times just before the latest measurement time. Additionally, in some implementations, the first time window may be configured to include the measurement time just before the latest measurement time, and one or more measurement times just before the latest measurement time. That is, the dynamic monitoring system 100 can compare metric data of the latest time window with metric data of past time windows.

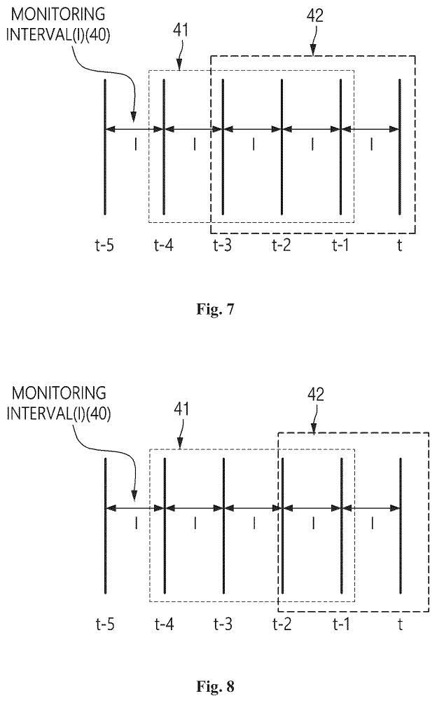

The first time window and the second time window will be described with reference to FIGS. 7 and 8.

FIG. 7 shows a first time window 41 and a second time window 42 set in the manner mentioned above. Moreover, each of the first time window 41 and the second time window 42 also shows a plurality of measurement times (t−5, t−4, t−3, t−2, t−1, and t) that are set according to the monitoring interval 40. The latest measurement time mentioned above is the measurement time t shown in FIG. 7.

The dynamic monitoring system 100 senses recent changes in the operational state of monitoring target resource and adjusts the monitoring level of monitoring target resource 10 based on the sensed changes. Accordingly, the dynamic monitoring system 100 compares the metric data of the second time window 42 configured to include the measurement time just before the latest measurement time and one or more measurement times just before the latest measurement time with the metric data of the first time window 41, which is the time window before in comparison with the second time window 42.

At this time, the dynamic monitoring system 100 compares the metric data of the second time window 42 instead of the metric data of the latest measurement time with the metric data of the first time window 41, thereby allowing the monitoring level to be gradually adjusted without being abruptly adjusted due to generation of metric data having an abnormally large amount of change in the latest measurement time.

In some implementations, the number of measurement times of the first time window may be greater than the number of measurement times of the second time window. For example, as shown in FIG. 8, the dynamic monitoring system 100 may react sensitively to metric data of the latest time window rather than the metric data of the past time window, by setting the number of measurement times of the second time window 42 to be smaller than the number of measurement times of the first time window 41. That is, it may be understood that the dynamic monitoring system 100 is more sensitive to changes in metric data of the latest time window than in metric data of past time windows in the process of analyzing the metric data.

The dynamic monitoring system 100 may automatically determine one of a basic setting in which the number of measurement times of the first time window is set to be equal to the number of measurement times of the second time window, and a sensitive setting in which the number of measurement times of the first time window is set to be larger than the number of measurement times of the second time window. For example, the dynamic monitoring system 100 may automatically determine either the basic setting or the sensitive setting, using an outlier occurrence frequency of the monitoring target metric of the monitoring target resource.

The dynamic monitoring system 100 may determine the basic settings for a virtual machine (VM) that includes a large number of metrics with a high frequency of outlier occurrence, thereby preventing the monitoring level from being adjusted upward unnecessarily in response to the occurrence of outlier. In contrast, the dynamic monitoring system 100 determines the sensitivity setting for a virtual machine that includes a large number of metrics for which the outlier occurrence frequency is less than a reference value, and sensitively monitors changes in metric data, thereby allowing the monitoring level to be adjusted upward in time.

The dynamic monitoring system 100 may determine one of the basic settings and the sensitive settings, using whether there is a time zone with high variations in the metric data. For example, if the time zone of a service region predetermined for a specific virtual machine is a predetermined early morning time zone (for example, from 2:00 a.m. to 5:00 a.m.), the dynamic monitoring system 100 may determine the basic setting, thereby preventing the monitoring level from being adjusted upward unnecessarily in the early morning time zone.

The dynamic monitoring system 100 may determine either the basic setting or the sensitive setting by analyzing the tag information of the virtual machine. For example, the dynamic monitoring system 100 determines whether the metric variation inferred using a machine-learned model that analyzes the tag information to predict the metric variation in the current time zone exceeds a reference value, and when the inferred metric variation exceeds the reference value, the dynamic monitoring system 100 may prevent the monitoring level from being adjusted upward unnecessarily at the early morning time zone by determining the basic setting.

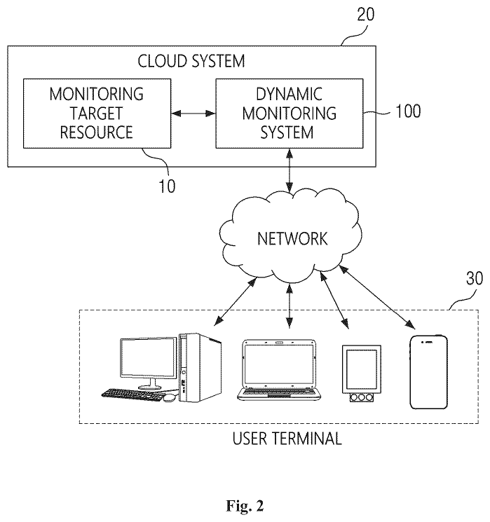

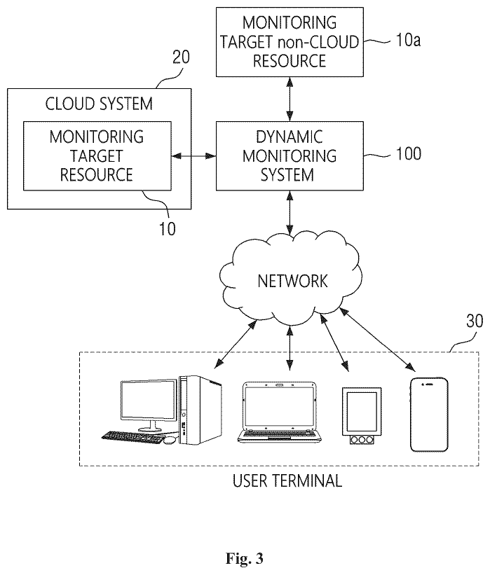

The description accompanying FIG. 1 of operation of the computing system focused on the operation of the dynamic monitoring system 100. As shown in FIG. 2, in the present example of a computing system, because the monitoring target resource 10 and the dynamic monitoring system 100 are located in the same cloud system 20, the speed of metric data acquisition on the monitoring target resource 10 of the dynamic monitoring system 100 may increase. Further, as shown in FIG. 3, the dynamic monitoring system 100 of the computing system may monitor both the monitoring target resource 10 inside the cloud system 20 and the monitoring target resource 10 of the on-premises environment rather than the cloud environment.

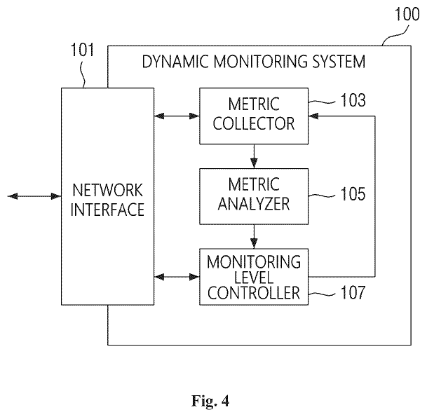

As shown in FIG. 4, another example of the dynamic monitoring system 100 includes a network interface 101, a metric collector 103, a metric analyzer 105, and a monitoring level controller 107. Each of the metric collector 103, the metric analyzer 105, and the monitoring level controller 107 may be implemented by software or in the form of separate processors.

The network interface 101 may provide a function of transmitting and receiving data to and from an external device.

The metric collector 103 may repeatedly collect monitoring target metric data of the monitored resource using a monitoring interval determined according to the monitoring level.

The metric analyzer 105 may analyze the metric data collected by the metric collector 103 and provide the results of the analysis to the monitoring level controller 107. For example, the metric analyzer 105 calculates a first representative value and a first standard deviation of metric data measured at a plurality of first measurement times belonging to a first time window, calculates a second representative value and a second standard deviation of the metric data measured at a plurality of second measurement times belonging to a second time window after the first time window, and may increase or decrease feedback, for the monitoring target resource, using at least one of a first comparison result between the first representative value and the second representative value, and a second comparison result between the first standard deviation and the second standard deviation. The ‘feedback’ may indicate a gauge in the current monitoring level. That is, if the feedback reaches the predefined positive maximum value in the current monitoring level, the monitoring level may increase, and if the feedback reaches the predefined negative maximum value in the current monitoring level, the monitoring level may decrease.

The first comparison result is obtained by dividing the representative value of the current time window by the representative value of the previous time window, and the second comparison result may be obtained by dividing the standard deviation of the current time window by the standard deviation of the previous time window.

The metric analyzer 105 sets the value of feedback for the monitoring target resource to a maximum value (+f) regardless of the value of the current feedback when a first condition reflecting the first comparison result or the second comparison result is established. When a second condition reflecting the second comparison result is established, the metric analyzer 105 may increase the value of feedback for the monitoring target resource by a predetermined value based on the value of the current feedback. When a third condition reflecting the second result is established, the metric analyzer 105 may decrease the value of feedback for the monitoring target resource by a predetermined value based on the value of the current feedback. At this time, the predetermined value may be “1”.

An example of the first to third conditions is shown in Formula 1 below.

$$( {1}^{st} condition ) {F}_{j}^{i} = f if \frac{{m}_{j}^{i} ( t )}{{m}_{j}^{i} ( t - 1 )} > {u}_{1}^{m} or \frac{{s}_{j}^{i} ( t )}{{s}_{j}^{i} ( t - 1 )} > {u}_{1}^{s} or \frac{{m}_{j}^{i} ( t )}{{m}_{j}^{i} ( t - 1 )} < {u}_{2}^{m} or \frac{{s}_{j}^{i} ( t )}{{s}_{j}^{i} ( t - 1 )} < {u}_{2}^{s} \qquad [ Formula 1 ]$$

$$( {2}^{nd} condition ) {F}_{j}^{i} = {F}_{j}^{i′} + 1 if {u}_{1}^{s} > \frac{{s}_{j}^{i} ( t )}{{s}_{j}^{i} ( t - 1 )} > {u}_{3}^{s} or {u}_{2}^{s} < \frac{{s}_{j}^{i} ( t )}{{s}_{j}^{i} ( t - 1 )} < {u}_{4}^{s} \qquad [ Formula 2 ]$$

$$( {3}^{rd} condition ) {F}_{j}^{i} = {F}_{j}^{i′} - 1 if {u}_{4}^{s} < \frac{{s}_{j}^{i} ( t )}{{s}_{j}^{i} ( t - 1 )} < {u}_{3}^{s} \qquad [ Formula 3 ]$$

In Formulas 1-3 above, Fⱼⁱ is the current feedback from the j^{th} metric of the i^{th} virtual machine (VM), e.g., Fⱼⁱ∈{−f, . . . , f}. Fⱼ^{i′} is the previous feedback from the j^{th} metric of the i^{th} VM. mⱼⁱ is a representative value of the j^{th} metric of the i^{th} VM. sⱼⁱ is the standard deviation of the j^{th} metric of the i^{th} VM. u₁^{m}, and u₂^{m} are predetermined, e.g., user defined, values of representative value thresholds. u₁^{s}, u₂^{s}, u₃^{s}, and u₄^{s} are predetermined, e.g., user defined, values of standard deviation value thresholds.

Formulas 1-3 will be further explained. First, Formulas 1-3 will be explained referring to a relation of 0<u₂^{m}<u₁^{m}, and 0<u₂^{s}><u₄^{s}<u₃^{s}<u₁^{s}.

The first condition is satisfied when the representative value of the current time window has changed in comparison with the representative value of the previous time window by a ratio greater than a user-defined limit value u₁^{m} or less than a user-defined limit value u₂^{m}.

Furthermore, the first condition can be satisfied when the standard deviation value of the current time window has changed in comparison with the representative value of the previous time window by a ratio greater than a user-defined limit value u₁^{s} or less than a user-defined limit value u₂^{s}.

The second condition is satisfied when the standard deviation value of the current time window has changed in comparison with the representative value of the previous time window by a ratio that is greater than user-defined limit value u₂^{s} and less than user-defined limit value u₄^{s} or by a ratio that is greater than user-defined limit value u₃^{s} and less than user-defined limit value u₁^{s}.

The third condition is satisfied when the standard deviation value of the current time window has changed in comparison with the representative value of the previous time window by a ratio that is greater than user-defined limit value u₄^{s} and less than user-defined limit value u₃^{s}.

The first condition can be satisfied depending on at least one of the representative values of the current time window and the previous time window, and the standard deviation value of the current time window and the previous time window. Accordingly, some implementations may allow the monitoring level to increase, by setting the value of feedback for the maximum value, when even any one of the representative value and the standard deviation value exhibits the level of variation, e.g., the ratios

$$\frac{{m}_{j}^{i} ( t )}{{m}_{j}^{i} ( t - 1 )} or \frac{{s}_{j}^{i} ( t )}{{s}_{j}^{i} ( t - 1 )} ,$$

exceeds the predetermined representative value thresholds, u₁^{m} or u₂^{m}. That is, the dynamic monitoring system 100 may decrease the interval of monitoring to increase responsiveness to sudden changes in monitoring target cloud resources, if the variation of the representative value or the standard deviation value between the current time window and the previous time window exhibits higher level than the predetermined thresholds. On the other hand, when neither the representative value nor the standard deviation value exhibits a level of variation that exceeds the limit value, e.g.,

$$\frac{{s}_{j}^{i} ( t )}{{s}_{j}^{i} ( t - 1 )} > {u}_{2}^{s} , \frac{{s}_{j}^{i} ( t )}{{s}_{j}^{i} ( t - 1 )} < {u}_{1}^{s} , \frac{{m}_{j}^{i} ( t )}{{m}_{j}^{i} ( t - 1 )} < {u}_{1}^{m} , and \frac{{m}_{j}^{i} ( t )}{{m}_{j}^{i} ( t - 1 )} > {u}_{2}^{m} ,$$

the dynamic monitoring system of some can avoid an unnecessary increase in the amount of calculation, by increasing or decreasing the value of feedback by a predetermined value based on only the variation in the standard deviation value, e.g., not depending on the variation in the representative value.

The monitoring level controller 107 may adjust the monitoring level, using the analysis results of the metric data provided from the metric analyzer 105. For example, the monitoring level controller 107 may adjust or maintain the monitoring level, using the feedback value. The monitoring level controller 107 may adjust the monitoring level downward by one level when the value of feedback is the minimum value and may adjust the monitoring level upward by one level when the value of feedback is the maximum value. Accordingly, the feedback value acts as a buffer that allows some extent of metric change to accumulate for upward or downward adjustment of the monitoring level. Then, the minimum and maximum values of the feedback values may be dynamically adjusted depending on the situation.

For example, as the monitoring level approaches the minimum value, absolute values of the minimum value and maximum value of the feedback values increase, and as the monitoring level approaches the intermediate value, the absolute values of the minimum value and maximum value of the feedback values decrease. Thus, the monitoring level may be adjusted in such a manner that is sensitive to changes in the metric in the intermediate monitoring level and is less sensitive to changes in the metric toward the minimum or maximum monitoring levels.

The monitoring level controller 107 may provide the latest monitoring level information to the metric collector 103 to cause the metric collector 103 to collect metrics according to the monitoring interval based on the latest monitoring level.

On the other hand, in some implementations, the dynamic monitoring system 100 may integrate and analyze metric data of the plurality of monitoring target resources, and adjust the monitoring level, using the analysis results thereof. That is, the dynamic monitoring system 100 may apply the same monitoring level to the plurality of monitoring target resources at once, thereby saving the computational resources devoted to determining individual monitoring levels for each monitoring target resource.

In this case, the metric analyzer 105 may send a first instruction that sets the value of feedback for the first virtual machine instance among the plurality of different virtual machine instances to the maximum value regardless of the value of the current feedback when the first condition is established. A second instruction increases a value of feedback for the first virtual machine instance by a predetermined value based on the value of the current feedback when the second condition is established. A third instruction decreases the value of feedback for the virtual machine instance by a predetermined value based on the value of the current feedback when the third condition is established. The metric analyzer 105 can also send one of the first to third instructions for each of the plurality of different virtual machine instances other than the first virtual machine instance.

That is, in this case, the metric analyzer 105 may calculate the final feedback value that reflects the feedback adjustment for all the virtual machines that are the monitoring targets, by repeatedly performing feedback adjustments for each virtual machine that is the monitoring target and may provide the final feedback value to the monitoring level controller 107.

The configuration and operation of the dynamic monitoring system and the computing system including the dynamic monitoring system have been described above. The operating method of the dynamic monitoring system of the present disclosure may be understood in more detail by referring to other examples to follow.

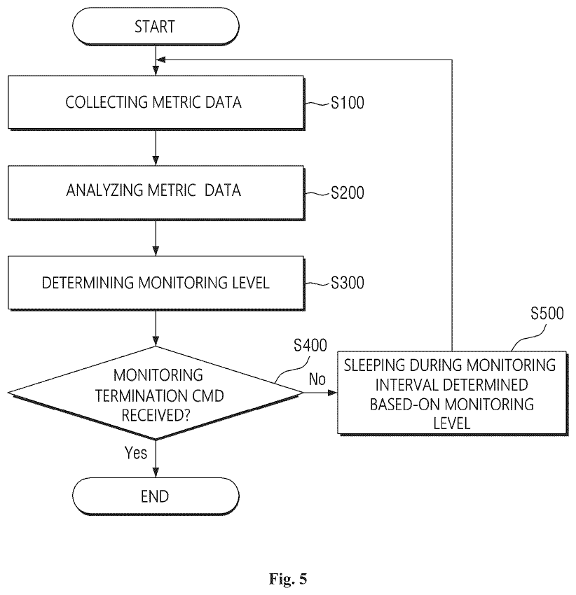

Hereinafter, another example of a dynamic monitoring method will be described with reference to FIG. 5. This dynamic monitoring method may be performed by one or more computing systems. Hereinafter, when the execution entity of each operation is omitted, the execution entity may be understood to be the above-mentioned computing system. Further, in this dynamic monitoring method, some operations may be performed by the first computing device, and the remaining operations may be performed by the second computing device. For example, some operations of the dynamic monitoring method may be performed by an on-premise physical server, and the remaining operations may be performed by a cloud compute instance.

As shown in FIG. 5, the dynamic monitoring method may include collection of metric data (S100), analysis of metric data (S200), and determination of monitoring level (S300). Step S100 may be understood as referring to the operation of the metric collector 103 described with reference to FIG. 4, step S200 may be understood as referring to the operation of the metric analyzer 105, and step S300 may be understood as referring to the operation of the monitoring level controller 107.

The dynamic monitoring method of FIG. 5 may include repeatedly performing step S100, step S200, and step S300 until an explicit monitoring end command is input from the user terminal (S400). However, to prevent the dynamic monitoring method from consuming excessive computing resources, monitoring may be performed according to monitoring interval. That is, between each measurement time, step S500 of sleeping for a cycle corresponding to the monitoring interval may be performed. The monitoring interval may be a period determined using the monitoring level determined in step S300.

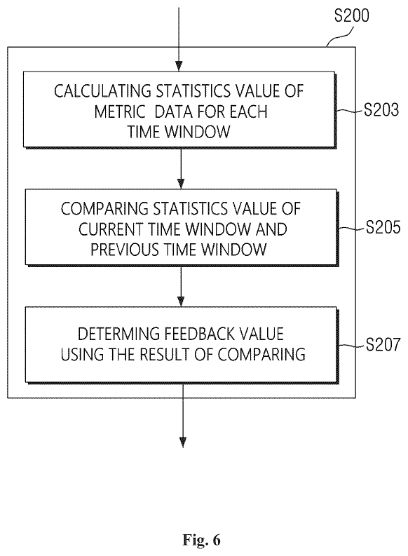

Hereinafter, the step for analyzing metric data will be described in detail with reference to FIG. 6.

First, in step S203, statistic values of metric data may be calculated for each type of window. This will be explained with reference to FIGS. 7 and 8. For example, it is possible to calculate the statistic value of the metric data of the second time window 42 that includes the latest measurement time, and the statistic value of the metric data of the first time window 41 that does not include the latest measurement time. In this regard, it will be appreciated that the second time window 42 is the current time window and the first time window 41 is the previous time window.

In some implementations, unlike that shown in FIG. 7 or 8, the last measurement time of the first time window 41 and the last measurement time of the second time window 42 may have two or more intervals. That is, if the change in metric data is insignificant and the amount of change needs to be amplified due to the operating characteristics of the monitoring target resource, the interval between the last measurement time and the latest measurement time of the first time window 41 may be further widened.

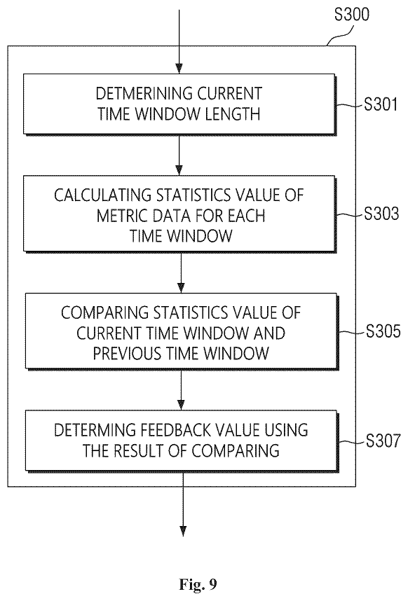

The step of determining the monitoring level will be described in detail below with reference to FIG. 9.

In step S301, the length of the current time window is determined. That is, the number of measurement times included in the current time window is determined. For example, the length of the current time window may be determined, depending on whether (i) the basic setting in which the number of measurement time of the previous time window is set to be equal to the number of measurement time of the current time window is followed or whether (ii) the sensitive setting in which the number of measurement times of the previous time window is set to be larger than the number of measurement times of the current time window is followed. Either the basic setting and sensitive setting can be automatically selected based on the methods described above.

In step S303, the average value of metric data for each time window is calculated. For example, a first representative value and a first standard deviation of metric data measured at the plurality of measurement times belonging to the previous time window, and a second representative value and a second standard deviation of the metric data measured at the plurality of measurement times belonging to the current time window may be calculated.

In step S305, at least one of a first comparison result between the first representative value and the second representative value, and a second comparison result between the first standard deviation and the second standard deviation may be generated. The first comparison result may be obtained by dividing the representative value of the current time window by the representative value of the previous time window, and the second comparison result may be obtained by dividing the standard deviation of the current time window by the standard deviation of the previous time window.

In step S307, a feedback value for the monitoring target resource may be determined, using the first comparison result and the second comparison result. Regarding the process by which the value of feedback is determined, reference may be made to the explanation given with reference to Formulas 1-3.

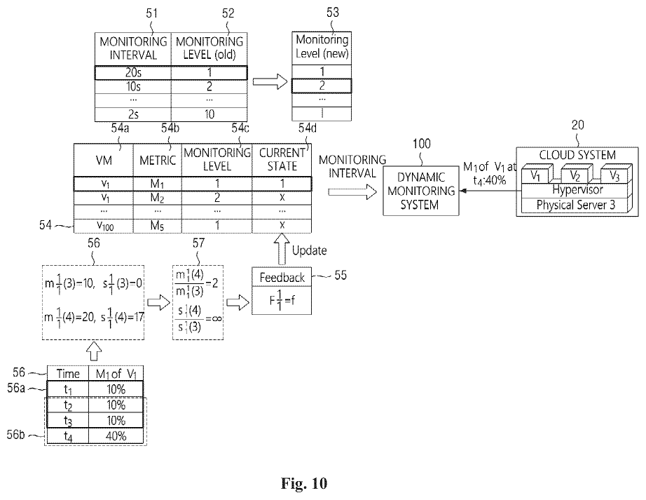

FIG. 10 is a diagram of an example of a dynamic monitoring method.

In some implementations, a mapping table between a monitoring interval 51 and a monitoring level 52 may be referenced. The mapping table may be stored as data, e.g., policy data, in the dynamic monitoring system 100.

A management table 54, which includes metric data 54b received from each monitoring target resource 54a, a monitoring level 54c, and a current state 54d indicating whether there is a need to change the monitoring level as fields, may also be stored in the dynamic monitoring system 100. The dynamic monitoring system 100 will continuously update the management table 54.

FIG. 10 shows an exemplary situation in which the monitoring target resource is a first virtual machine V1 among a plurality of virtual machines provisioned in the cloud system 20, and the value of the first metric M1 of the first virtual machine is continuously maintained at 10% for first measurement time to third measurement time t1, t2 and t3, and the value increases to 40% at the fourth measurement time t4, which is the latest measurement time. The value of the first metric at each measurement time is stored in the metric data table 56.

In this case, an average (m₁¹(tₓ) i=1, j=1, and x=1, 2, 3) of the first metric of the first time window 56a from the first measurement time to the third measurement time t1, t2, and t3 is 10 (%), and a standard deviation (s₁¹(tₓ) i=1, j=1, and x=1, 2, 3, e.g., “s₁¹(3)”) is 0. Further, an average (m₁¹(tₓ) i=1, j=1, and x=2,3,4) of the first metric of the second time window 56b from the second measurement time to the fourth measurement time t2, t3, and t4 is 20 (%), and a standard deviation (s₁¹(tₓ) i=1, j=1, and x=2,3,4) is 17. FIG. 10 shows this statistic value calculation result 56. mⱼⁱ(x) in FIG. 10 may indicate an average value of i^{th} metric of j^{th} virtual machine of every measurement time in the time window comprising the x^{th} measurement time as a last measurement time. Also, sⱼⁱ(x) in FIG. 10, may indicate a standard deviation value of i^{th} metric of j^{th} virtual machine of every measurement time in the time window comprising the x^{th} measurement time as a last measurement time.

At this time, a statistical comparison calculation in which the average of the first metric of the second time window is divided by the average of the first metric of the first time window, and the standard deviation of the first metric of the second time window is divided by the standard deviation of the first metric of the first time window may be performed (57). A feedback value (Fⱼⁱ, a feedback value of a j^{th} metric of an i^{th} virtual machine, Fⱼⁱ∈{−f, . . . , f}) is determined, using the results of this comparison.

In the example of FIG. 10, the result obtained by dividing the standard deviation of the first metric of the second time window by the standard deviation of the first metric of the first time window from is calculated to be infinity (∞), e.g., because s₁¹(3)=0, which means an increase in variation of the first metric that exceeds the reference value, and therefore, the value of feedback is determined to be F at the maximum value (55). As a result, the value of the current state 54d field of the first virtual machine V1 will be updated to “1”, meaning one above of the monitoring level. Therefore, the new monitoring level 53 of the first virtual machine V1 will increase by one from 1 to 2. Accordingly, the monitoring interval for the first virtual machine from 20 may decrease from 20 seconds to 10 seconds.

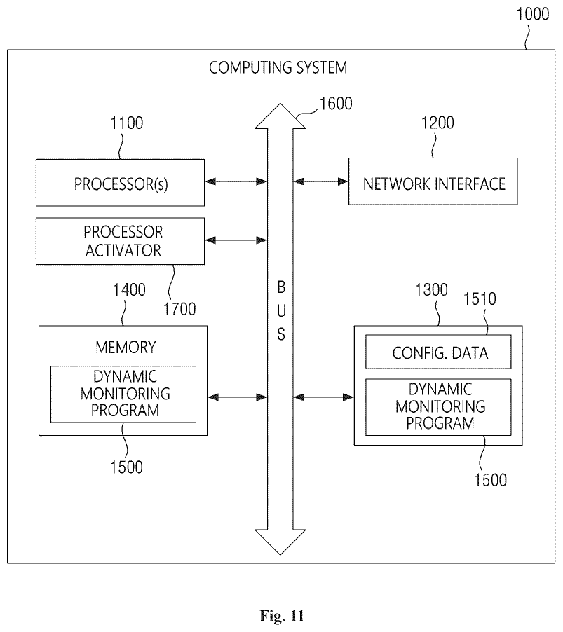

FIG. 11 is a diagram of an example of hardware configuration of a computing system 1000. The computing system 1000 of FIG. 13 may refer to, for example, the dynamic monitoring system 100 described with reference to FIG. 1. The computing system 1000 includes one or more processors 1100, a system bus 1600, a communication interface 1200, a memory 1400 for loading a computer program 1500 executed by the processor 1100, and a storage 1300 for storing the computer program 1500. The computing system 1000 may be provisioned through a cloud service, and in this case, one or more processors 1100, the communication interface 1200, the memory 1400, and the storage 1300 may all be virtualized resources.

The processor 1100 controls the overall operation of each component of the computing system 1000. The processor 1100 may perform calculations on at least one application or program for executing various methods/operations. The memory 1400 stores various types of data, instructions and/or information. The memory 1400 may load one or more computer programs 1500 from the storage 1300 to perform various methods/operations. The system bus 1600 provides communication functionality between components of the computing system 1000. The communications interface 1200 supports Internet communications of the computing system 1000. The storage 1300 may non-temporarily store one or more computer programs 1500.

Furthermore, the storage 1300 may store setting data 1510 for performing dynamic monitoring. The setting data 1510 may include various dynamic monitoring related settings described above, such as monitoring intervals for each monitoring level.

The computer program 1500 may include one or more instructions that implement methods/operations according to various embodiments of the present disclosure. When the computer program 1500 is loaded into the memory 1400, the processor 1100 may perform various methods/operations by executing one or more instructions.

The computer program 1500 may include an instruction for obtaining a first representative value and a first standard deviation of metric data measured at a first plurality of measurement times belonging to the first time window, an instruction for obtaining a second representative value and a second standard deviation of the metric data measured at a second plurality of measurement times belonging to the second time window subsequent to the first time window, an instruction for increasing or decreasing the feedback for the monitoring target resource using at least one of the first comparison result between the first representative value and the second representative value, and a second comparison result between the first standard deviation and the second standard deviation, and an instruction for adjusting the monitoring level for the monitoring target resource based on the feedback.

In some implementations, the computing system 1000 may further include a processor activator 1700 that switches between idle/active modes of the processor 1100. The computer program 1500 may further include an instruction for controlling the processor activator 1700 to switch between idle/active modes of the processor 1100 based on a monitoring interval determined by the monitoring level.

The advantages and features of the present disclosure and methods of accomplishing the same may be understood more readily by reference to the following detailed description of the previous examples and accompanying drawings. The present disclosure may, however, be embodied in many different forms and should not be construed as being limited to the embodiments set forth herein.

The singular expressions used in the present disclosure include plural concepts, unless the context clearly specifies singularity. Additionally, plural expressions include singular concepts, unless the context clearly specifies plurality. In addition, terms such as first, second, A, B, (a), (b) used in the present disclosure are only used to distinguish one element from another element, and the terms do not limit the nature, sequence, or order of the relevant elements.

The elements described with reference to terms such as unit, module, block, ˜or, ˜er, etc. used in the present disclosure and the functional blocks shown in the drawings may be implemented in the form of software, hardware, or a combination thereof. For example, the software may be machine code, firmware, embedded code, and application software. For example, the hardware may include an electrical circuit, an electronic circuit, a processor, a computer, an integrated circuit, integrated circuit cores, passive components, or a combination thereof.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The technical ideas of the present disclosure described so far can be implemented as computer-readable code on a computer-readable medium. The computer program recorded on the computer-readable recording medium can be transmitted to another computing device through a network such as the Internet, installed on the other computing device, and thus used on the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. Although embodiments of the present disclosure have been described above with reference to the attached drawings, those skilled in the art will understand that the present disclosure may be implemented in other specific forms without changing the technical idea or essential features. The embodiments described above should be understood in all respects as illustrative and not restrictive. The scope of protection of the present disclosure should be interpreted in accordance with the claims below, and all technical ideas within the equivalent scope should be construed as being included in the scope of rights of the technical ideas defined by this disclosure.

What is claimed is:

1. A dynamic monitoring system comprising:
a memory configured to load dynamic monitoring program;
one or more processors configured to execute the dynamic monitoring program; and
a network interface configured to receive metric data from a monitoring target resource,
wherein the dynamic monitoring program is configured to, when executed by the one or more processors, cause the dynamic monitoring system to perform operations comprising:
obtaining a first representative value and a first standard deviation of the metric data measured at a first plurality of measurement times belonging to a first time window;
obtaining a second representative value and a second standard deviation of the metric data measured at a second plurality of measurement times belonging to a second time window subsequent to the first time window;
increasing or decreasing feedback for the monitoring target resource, using at least one of (i) a first comparison result between the first representative value and the second representative value or (ii) a second comparison result between the first standard deviation and the second standard deviation; and
adjusting a monitoring level for the monitoring target resource based on the feedback.

2. The dynamic monitoring system of claim 1, wherein a number of measurement times of the first plurality of measurement times belonging to the first time window is greater than or equal to a number of measurement times of the second plurality of measurement times belonging to the second time window.

3. The dynamic monitoring system of claim 2, wherein a number of measurement times of the first plurality of measurement times belonging to the first time window is greater than a number of measurement times of the second plurality of measurement times belonging to the second time window.

4. The dynamic monitoring system of claim 3, wherein, based on an outlier occurrence frequency of the metric data for the monitoring target resource being less than a reference value, the number of measurement times of the first plurality of measurement times belonging to the first time window is greater than the number of measurement times of the second plurality of measurement times belonging to the second time window.

5. The dynamic monitoring system of claim 3, wherein, in a predetermined first time band, the number of measurement times of the first plurality of measurement times belonging to the first time window is greater than the number of measurement times of the second plurality of measurement times belonging to the second time window.

6. The dynamic monitoring system of claim 3, wherein the monitoring target resource includes a cloud compute instance, and
wherein obtaining the second representative value and the second standard deviation of metric measured at the second plurality of measurement times belonging to the second time window includes:
performing (i) a time window setting in which the number of measurement times of the first plurality of measurement times belonging to the first time window is greater than the number of measurement times of the second plurality of measurement times belonging to the second time window, or (ii) a time window setting in which the number of measurement times of the first plurality of measurement times belonging to the first time window is the same as the number of measurement times of the second plurality of measurement times belonging to the second time window, using tag information of the cloud compute instance.

7. The dynamic monitoring system of claim 1, wherein increasing or decreasing feedback for the monitoring target resource includes:
setting a value of the feedback for the monitoring target resource to a maximum value regardless of the value of a current feedback, based on a first condition being satisfied;
increasing the value of the feedback for the monitoring target resource by a predetermined value based on the value of the current feedback, based on a second condition being satisfied; and
decreasing the value of the feedback for the monitoring target resource by a predetermined value based on the value of the current feedback, based on a third condition being satisfied.

8. The dynamic monitoring system of claim 1, wherein the monitoring target resource includes a plurality of different virtual machine instances provisioned on one physical server, and
wherein increasing or decreasing feedback for the monitoring target resource includes:
setting a value of the feedback for a first virtual machine instance to a maximum value regardless of the value of a current feedback, based on a first condition is satisfied;
based on a second condition is satisfied, increasing the value of the feedback for the first virtual machine instance by a predetermined value based on the value of the current feedback;
based on a third condition is satisfied, decreasing the value of the feedback for the first virtual machine instance by a predetermined value based on the value of the current feedback; and
performing one of (i) the setting of the value of the feedback, (ii) the increasing of the value of the feedback, and (iii) the decreasing of the value of the feedback for each of a plurality of different virtual machine instances except the first virtual machine instance.

9. The dynamic monitoring system of claim 8, wherein adjusting the monitoring level for the monitoring target resource includes:
adjusting the monitoring level of the monitoring target resource downward by one level, based on the value of the feedback is the minimum value; and
adjusting the monitoring level of the monitoring target resource upward by one level based on the value of the feedback being the maximum value.

10. The dynamic monitoring system of claim 8, wherein the first condition is a condition including a first comparison result between the first representative value and the second representative value, and a second comparison result between the first standard deviation and the second standard deviation, and
wherein the second condition and the third condition are conditions including a third comparison result between the first standard deviation and the second standard deviation.

11. A dynamic monitoring method, the method comprising:
receiving, using a network interface of one or more computing devices, metric data from a monitoring target resource;
obtaining, using one or more computing devices, a first representative value and a first standard deviation of the metric data measured at a first plurality of measurement times belonging to a first time window;
obtaining, using one or more computing devices, a second representative value and a second standard deviation of the metric data measured at a second plurality of measurement times belonging to a second time window subsequent to the first time window;
increasing or decreasing, using one or more computing devices, a feedback for the monitoring target resource, using at least one of (i) a first comparison result between the first representative value and the second representative value, or (ii) a second comparison result between the first standard deviation and the second standard deviation; and
adjusting, using one or more computing devices, a monitoring level for the monitoring target resource based on the feedback.

12. The dynamic monitoring method of claim 11, wherein a number of measurement times of the first plurality of measurement times belonging to the first time window is greater than or equal to a number of measurement times of the second plurality of measurement times belonging to the second time window.

13. The dynamic monitoring method of claim 12, wherein the number of measurement times of the first plurality of measurement times belonging to the first time window is greater than the number of measurement times of the second plurality of measurement times belonging to the second time window.

14. The dynamic monitoring method of claim 13, wherein, based on an outlier occurrence frequency of the metric data for the monitoring target resource being less than a reference value, the number of measurement times of the first plurality of measurement times belonging to the first time window is greater than the number of measurement times of the second plurality of measurement times belonging to the second time window.

15. The dynamic monitoring method of claim 13, wherein, in a predetermined first time band, the number of measurement times of the first plurality of measurement times belonging to the first time window is greater than the number of measurement times of the second plurality of measurement times belonging to the second time window.

16. The dynamic monitoring method of claim 13, wherein the monitoring target resource includes a cloud compute instance, and
wherein obtaining the second representative value and the second standard deviation of metric measured at the second plurality of measurement times belonging to the second time window includes:
performing time window setting in which the number of measurement times of the first plurality of measurement times belonging to the first time window is greater than the number of measurement times of the second plurality of measurement times belonging to the second time window, or time window setting in which the number of measurement times of the first plurality of measurement times belonging to the first time window is the same as the number of measurement times of the second plurality of measurement times belonging to the second time window, using tag information of the cloud compute instance.

17. The dynamic monitoring method of claim 11, wherein increasing or decreasing feedback for the monitoring target resource includes:
setting a value of feedback for the monitoring target resource to a maximum value regardless of a value of current feedback, based on a first condition being satisfied;
increasing the value of the feedback for the monitoring target resource by a predetermined value based on the value of the current feedback, based on a second condition being satisfied; and
decreasing the value of the feedback for the monitoring target resource by a predetermined value based on the value of the current feedback, based on a third condition being satisfied.

18. The dynamic monitoring method of claim 11, wherein the monitoring target resource includes a plurality of different virtual machine instances provisioned on one physical server, and
wherein increasing or decreasing feedback for the monitoring target resource includes:
setting a value of the feedback for a first virtual machine instance to a maximum value regardless of the value of a current feedback, based on a first condition being satisfied;
increasing the value of the feedback for the first virtual machine instance by a predetermined value based on the value of the current feedback, based on a second condition being satisfied;
decreasing the value of the feedback for the first virtual machine instance by a predetermined value based on the value of the current feedback, based on a third condition being satisfied; and
performing one of (i) the setting of the value of the feedback, (ii) the increase of the value of the feedback, and (iii) the decrease of the value of the feedback for each of a plurality of different virtual machine instances except the first virtual machine instance.

19. The dynamic monitoring method of claim 18, wherein adjusting the monitoring level for the monitoring target resource includes:
adjusting the monitoring level of the monitoring target resource downward by one level, based on the value of the feedback being the minimum value; and
adjusting the monitoring level of the monitoring target resource upward by o411ne level, based on the value of the feedback being the maximum value.

20. The dynamic monitoring method of claim 18, wherein the first condition is a condition including a first comparison result between the first representative value and the second representative value, and a second comparison result between the first standard deviation and the second standard deviation, and
wherein the second condition and the third condition are conditions including a third comparison result between the first standard deviation and the second standard deviation.
